(19) United States
(12) Patent Application Publication
(10) Pub. No.: US 2024/0220630 A1
(43) Pub. Date: Jul. 4, 2024

(54) TYPOSQUATTING DETECTION VIA METADATA-BASED TRUSTWORTHINESS SCORING AND PACKAGE IDENTIFIER SIMILARITY

(71) Applicant: Palo Alto Networks, Inc., Santa Clara, CA (US)

(72) Inventors: Daniel Prizmant, Sunnyvale, CA (US); Ariel M. Zelivansky, Mountain View, CA (US); Sharon Ben Zeev, Tel Aviv (IL); Shaul Ben Hai, Petah Tikva (IL)

(73) Assignee: Palo Alto Networks, Inc., Santa Clara, CA (US)

(21) Appl. No.: 18/150,143

(22) Filed: Jan. 4, 2023

(51) Int. Cl. G06F 21/57; G06F 21/51

(52) U.S. Cl. CPC G06F 21/577; G06F 21/51; G06F 2221/033

(57) ABSTRACT

A typosquatting detection agent (“agent”) detects typosquatting in monitored user traffic at an endpoint device using features generated from metadata of a pull request to a package or container and trustworthiness scores of packages or containers with similar identifiers. The agent, upon detection of the pull request to the package or container, retrieves metadata for the package or container and generates a trustworthiness score for the package or container based on the metadata features. The agent then applies one or more criteria to the generated trustworthiness score and the scores of packages or containers with similar identifiers to identify typosquatting at the endpoint device.

### BACKGROUND

The disclosure generally relates to CPC class G06F and subclass 21/50 and/or 21/56.

Typosquatting is a type of cyberattack that attempts to dupe users by employing Uniform Resource Locators (URLs), filenames, or other user-queried/requested string identifiers that resemble legitimate identifiers as identifiers of malicious content. The typosquatting string identifiers are designed to mimic trusted/known string identifiers such that the corresponding content is believed to be trustworthy. Typosquatting is advertised on falsified tutorial websites and other resources facilitating user tasks which adds to user trust and increases likelihood of attack success.

### BRIEF DESCRIPTION OF THE DRAWINGS

Embodiments of the disclosure may be better understood by referencing the accompanying drawings.

FIG. 1 is a schematic diagram of an example system for detecting typosquatting with repository-based features and trustworthiness score criteria.

FIG. 2 is an illustrative diagram of criteria for detecting typosquatting and trustworthy packages based on trustworthiness scores of a requested package and packages with similar identifiers.

FIG. 3 is a flowchart of example operations for detecting typosquatting with repository and/or registry-originating features.

FIG. 4 is a flowchart of example operations for retrieving trustworthiness scores for previously requested software packages with similar identifiers to a requested software package.

FIG. 5 is a flowchart of example operations for applying trustworthiness criteria to retrieved scores and a requested package score to generate a verdict for a software package request.

FIG. 6 depicts an example computer system with a typosquatting detection agent and a trustworthiness score database.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

Requests to pull software packages including container images for download, installation, and execution from public and private repositories poses a cybersecurity risk due to attackers uploading malicious software packages that resemble known/trustworthy versions. A common such cyberattack comprises changing identifiers such as filenames, executable names, etc. to closely resemble the trustworthy version (e.g., “nginx” versus “mginx”). Readily available metadata for repositories of software packages can be a strong indicator for whether user-requests are directed at trustworthy or malicious versions. A typosquatting detection agent (“agent”) disclosed herein detects requests to hosts maintaining repositories and leverages this metadata to identify and mitigate requests to typosquatting software packages and containers.

The agent monitors user traffic, for example at an endpoint, to detect when a user request is made to a repository storing software packages. Upon detection, the agent queries a database of known software packages with an identifier for the requested package. The database searches for previously requested packages with same or similar identifiers and corresponding trustworthiness scores. If the requested identifier has not been previously requested, then the agent queries a host(s) of the repository for associated metadata such as a number of downloads, number of stars, source, etc. for feature generation. The agent then converts the metadata into numerical features and computes a weighted sum of the numerical features as a trustworthiness score for the requested software package (“package”). Each of the numerical features is engineered to positively correlate with trustworthiness and weights are chosen according to known importance.

For malicious package detection, the agent compares the score for the requested package to scores of the previously requested packages with same or similar identifiers. A first criterion for maliciousness is whether the difference between one of the previously requested scores and the requested package score is below a first threshold, which prompts termination of the pull request to the requested package. A second criterion for maliciousness is whether the difference between one of the previously requested scores and the requested package score is below a second (smaller) threshold, which prompts a user alert that the package may be malicious. The database maintains and updates scores by adding the score of the requested package in association with its identifier as well as an indication of whether typosquatting was suspected/detected. Utilizing the metadata for package requests and comparison thereof to similarly identified packages boosts typosquatting detection by incorporating numerical trustworthiness features and leveraging group trustworthiness according to multitudes of scores for packages with proximal identifiers.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

“Container” refers to code units that execute on an operating system and are isolated from processes running on the operating system external to the container. Commands to view root level directories running processes, and available hardware are oblivious to directories, processes, and hardware outside of the container. In contrast to virtual machines, multiple containers can execute on a single operating system. Container isolation is orchestrated by software such as Docker® software that provides operating system level virtualization. Containers can be delivered as downloadable executables referred to as “container images”. Container images are executable files that include configuration files, libraries, library references, executable code, and all other necessary code units such that, once run, initialize the execution and configuration of the corresponding container.

“Software package” and “package” refer to collections of files that include executable software files, dependencies, metadata for the software, configuration files, and other files pertinent to managing corresponding software. Software package management can be facilitated by a “package manager” which helps users install, upgrade, uninstall, and/or configure software. Software packages may require additional installations for external software dependencies not included. Container and software packages are maintained/distributed by repositories that are managed by hosts and/or services. The hosts and/or services can specify an application programming interface (API) or syntax for querying the hosts and/or services for packages, containers, and metadata thereof.

“Request” and “pull request” refer to requests to download/obtain packages/container images for local execution/installation on an endpoint device.

### Example Illustrations

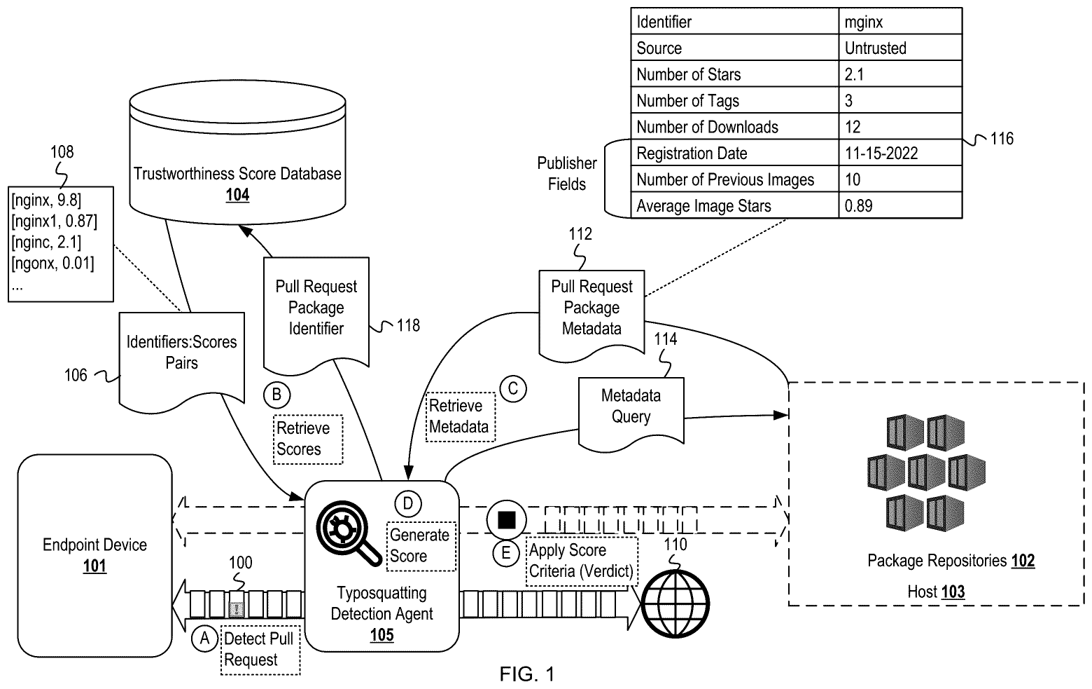

FIG. 1 is a schematic diagram of an example system for detecting typosquatting with repository-based features and trustworthiness score criteria. A typosquatting detection agent (“agent”) 105 monitors traffic between an endpoint device 101 and the Internet 110. Upon detecting a software package pull request (“request”) 100 to package repositories 102, the agent 105 queries a trustworthiness score database (“database”) 104 with a pull request package identifier (“identifier”) 114 for the request 100. Additionally, the agent 105 sends a metadata query 114 to a host 103 of the package repositories 102 to ascertain trustworthiness of the pull request. The database 104 returns similar identifier/trustworthiness score pairs (“pairs”) 106 corresponding to previously requested packages in the database 104 having sufficiently similar identifiers to a pull request package identifier (“identifier”) 118 of the request 100. Finally, the agent 105 determines whether the request 100 is trustworthy according to a trustworthiness score of the request 100 generated from metadata as well as scores for packages with similar identifiers indicated in the pairs 106. Based on a determination that the request 100 is for a malicious package (i.e., that a malicious attacker has typosquatted the package corresponding to the request 100), the agent 105 performs corrective action including terminating connections between the endpoint device 101 and the host 103.

FIG. 1 is annotated with a series of letters A-E. Each stage represents one or more operations. Although these stages are ordered for this example, the stages illustrate one example to aid in understanding this disclosure and should not be used to limit the claims. Subject matter falling within the scope of the claims can vary from what is illustrated. For instance, the agent 105 can monitor traffic from the endpoint device 101 to multiple hosts simultaneously and, in parallel, can query for metadata of multiple requests, retrieve trustworthiness scores of packages with similar identifiers, and perform corrective action for each of the requests in tandem. These operations can occur interchangeably across the various requests and in any order that is efficient and/or secure for the endpoint device 101 according to configuration of the agent 105.

At stage A, the agent 105 detects the request 100 communicated from the endpoint device 101 to the host 103 for a package stored on the package repositories 102. The agent 105 continuously monitors traffic from the endpoint device 101 to the Internet 110 for malicious behavior and can be running inline on the endpoint device 101 or on an intermediary firewall in the cloud. The agent 105 can keep a log of existing sessions/flows at the endpoint device 101 (e.g., by logging and analyzing pcap files) and can associate each session/flow with a corresponding application. The agent 105 can further have signatures stored thereon that model normal behavior for each application and can compare session/flow traffic against the signatures for malicious behavior detection. Pull requests to repositories can be associated with certain applications running on the endpoint device 101 and the agent 105 can be configured to monitor for pull requests and abnormal behavior specifically within traffic sessions/flows associated with those applications.

Traffic communicated between the endpoint device 101 and the Internet 110 is depicted with a solid double-sided arrow while traffic communicated between the endpoint device 101 and the host 103 is depicted with a dotted double-sided arrow. This is for illustrative purposes. In embodiments where communication from endpoint device 101 to host 103 occurs via the Internet 110, the traffic to and from the host 103 depicted as dotted is a subset of the traffic to and from the Internet 110 depicted as solid.

At stage B, the agent 105 queries the database 104 with the identifier 118 corresponding to the request 100 to retrieve scores for packages with similar identifiers. The database 104 searches for package identifiers with similar scores. For instance, the database 104 can search for package identifiers with a Levenshtein distance to the identifier 118 below a threshold Levenshtein distance. The threshold Levenshtein distance can be a fixed distance determined based on analysis of previous typosquatting instances for pull requests to the package repositories 102. The database 104 can further limit the number of similar identifiers to a threshold number of identifiers. The threshold number of identifiers and threshold Levenshtein distance can be indicated in a message/query indicating the identifier 118 communicated by the agent 105 or can be parameters set at the database 104. Other quantifiable notions of similarity such as semantic similarity according to natural language processing embeddings of the identifiers can be used.

The database 104 retrieves a list of similar identifiers and corresponding scores and returns them to the agent 105 as pairs 106. An example list 108 of identifier trustworthiness score pairs is the following:
[nginx, 9.8]
[nginx1, 0.87]
[nginc, 2.1]
[ngonx, 0.01]
. . . .
   The example list 108 is for a corresponding example identifier “mginx” of the request 100. The high trustworthiness score 9.8 for the “nginx” identifier relative to the other trustworthiness scores 0.87, 2.1, and 0.01 suggests that this is the trusted package. Note that each of the identifiers in the example list 108 has a Levenshtein distance less than or equal to two with “mginx” so the threshold distance for similar identifiers could be (for instance) 3.

At stage C, the agent 105 communicates the metadata query 114 to the host 103 to retrieve metadata for the package corresponding to the request 100. The metadata query 114 indicates the identifier 118 for the request 100 as well desired metadata fields such as a package source, a number of stars, a number of tags, a number of downloads, a registration date of the publisher, a number of previous images of the publisher, and an average number of image stars for the publisher. The agent 105 communicates with the host 103 via channels and according to syntax dictated by the host 103, for instance an API to a service at the host 103 that includes functionality for querying for metadata of packages by identifier. Alternatively, the agent 105 can send a Hypertext Transfer Protocol (HTTP) request to a uniform resource locator (URL) for a website hosted by the host 103 that corresponds to the identifier 118. To exemplify, the website can have specific syntax such as “example.com/_/*” such that query to the URL with a package identifier in the “*” placeholder will return a HTTP response including a webpage for the package (or a HTTP 404 response code if no such package exists), and the agent 105 can mine the HTTP response for metadata of the package. The agent 105 can, alternatively, send an HTTP response to a URL having search functionality such as “example.com/search?q=*” where “*” is the identifier of the package and can query an additional URL returned in an HTTP response as search results. The agent 105 can communicate a separate query in the metadata query 114 for publisher features according to any of the previous embodiments.

The host 103 returns pull request package metadata (“package metadata”) 112 to the agent 105. Example metadata 116 for a package comprises the following:
Identifier|mginx
Source|Untrusted
Number of Stars|2.1
Number of Tags|3
Number of Downloads|12
Registration Date|11-15-2022
Number of Previous Images|10
Average Image Stars|0.89
The last 3 metadata fields correspond to a publisher of the package.

At stage D, the agent 105 generates a score for the package indicated in the request 100 according to the package metadata 112. The agent 105 generates numerical features for each of the fields indicated in the package metadata 112. The agent 105 can convert string features into numerical features and normalize the numerical features to be in a same range (e.g., [0,1]). To exemplify, for the example metadata 116, the “Source” metadata field can be converted to a 1 or 0 numerical feature based on trustworthiness of the indicated source (e.g., 1 for verified publishers, verified open-source projects, and official packages at the package repositories 102, and 0 for other sources). Number of stars and average image stars for the publisher can be scaled by maximal number of stars, e.g., divide by 5. Number of tags, number of downloads and number of previous images for the publisher can be scaled with a quantile transformation against other packages/publishers in the package repositories 102 (wherein the quantiles are scaled to lie in [0,1]). Registration date can be scaled by a time-based distribution that weights publishers with older registration dates higher that publishers with newer registration dates but does not unreasonably upscale registration dates beyond a fixed time horizon in the past. These examples are given for the purposes of illustration and any appropriate types of scaling and methods of standardization can be implemented.

After generating normalized numerical features for each metadata field indicated in the package metadata 112, the agent 105 generates a weighted sum of the normalized numerical features. When the normalized numerical feature values are denoted {fᵢ}ᵢ and the weights are denoted {wᵢ}ᵢ, then the weight sum is computed as Σᵢfᵢwᵢ. The weights can be determined by a domain-level expert based on known importance of each feature for typosquatting detection. Alternatively, the weights can be determined using regression on the normalized numerical feature values for previous typosquatting/non-typosquatting instances with the feature values as the explanatory variable and the typosquatting outcome (i.e., 1 for typosquatting and 0 for non-typosquatting) as the response variable. This regression determines relative importance of each of the explanatory variables (features) for predicting the response variable (typosquatting outcome) as the weights. The agent 105 can query the database 104 for numerical features for previously requested typosquatting and non-typosquatting packages. Other machine-learning based methods can be used to determine feature weights.

At stage E, the agent 105 applies one or more score criteria to the score generated for the request 100 and scores returned in the pairs 106 for packages with similar identifiers. Suppose the score for the request 100 is denoted s and the scores indicated in the pairs 106 are {sᵢ}ᵢ₌₁ⁿ. Then a first criterion that the request 100 is typosquatting is that for at least one score sᵢ:

$$\\ {s}_{i} - s > {τ}_{1} ,$$

i.e., that the difference between at least one of the scores {sᵢ}ᵢ and the score of the request 100 is above a threshold τ₁. This first criterion indicates that the score of the request 100 is significantly below at least one score for packages of similar identifiers and therefore is not trustworthy. The parameter τ₁ can be tuned based on previous typosquatting/non-typosquatting instances. If the above inequality is not satisfied, then a second criterion for determining that the request 100 is typosquatting is that, for at least one score sᵢ:

$$\\ {s}_{i} - s > {τ}_{2}$$

for a threshold τ₂<τ₁, i.e., that the difference between at least one of the scores {sᵢ}ᵢ and the score of the request 100 is above a (smaller) threshold τ₂. The second criterion indicates that the score of the request 100 is smaller but not significantly smaller than at least one score for packages of similar identifiers. Note that for each of these criteria, it is sufficient to check the inequality for the maximal of the scores {sᵢ}ᵢ because the difference sᵢ−s using the maximal sᵢ is largest. If the score of the request 100 fails the first criterion and satisfies the second criterion, then the request 100 may not be trustworthy and lesser corrective action than a score satisfying the first criterion may be warranted.

Additional and alternative criteria to the above can be applied to s, {sᵢ}ᵢ₌₁ⁿ for typosquatting detection. For instance, the criteria can comprise that one of the scores sᵢ is significantly higher than the remaining scores (including the score of the request 100). In the above examples, typosquatting is detected if any of multiple criteria are satisfied. Alternatively, typosquatting can be detected if a threshold number of criteria are satisfied. Different trustworthiness scores can beget different criteria and different parameters tuned according to prior typosquatting for those different scores.

If the agent 105 determines that the scores s, {sᵢ}ᵢ₌₁ⁿ satisfy one of the above criteria (i.e., that the request 100 corresponds to a typosquatting attack), then the agent 105 performs corrective action for the endpoint device 101. If the first criterion is satisfied, the agent 105 terminates any established flows/sessions between the endpoint device 101 and the host 103 that corresponds to the request 100 (e.g., flows/sessions associated with an application for the request 100). Additionally, the agent 105 can issue a warning to the endpoint device 101 that indicates to a user that typosquatting has been detected along with the identifier 118 and any similar package identifiers that are known to be trustworthy (for instance, a package identifier corresponding to a score that satisfies the second criterion above). The agent 105 can issue instructions to locally delete any data downloaded from the request 100 from memory at the endpoint device 101 and terminate any processes related to download, installation, execution, etc. of the requested package. If the first criterion is not satisfied but the second criterion is satisfied, the agent 105 issues a warning at the endpoint device 101 that indicates the requested package may be malicious and asks the user whether to proceed. The agent 105 communicates the identifier 118 associated with the generated score s to the database 104 along with an indication of whether the package corresponding to the identifier 118 corresponds to a typosquatting attack for storage and future typosquatting detection. When one of the scores {sᵢ}ᵢ is significantly larger (e.g., according to a tunable threshold) than the remaining scores including the score s of the request 100, the agent 105 can suggest the package corresponding to the significantly larger score as a trustworthy alternative for the requested package.

FIG. 1 is depicted as retrieving scores for previously requested packages with similar identifiers from the database 104. In some embodiments, the agent 105 can update these scores when evaluating the request 100 for typosquatting by querying the host 103 or other hosts from which the packages were requested for metadata and generating trustworthiness scores in the same manner as at stages C and D for the request 100. The agent 105 can consider criteria such as time period length since packages indicated in the pairs 106 were last evaluated for typosquatting when updating trustworthiness scores.

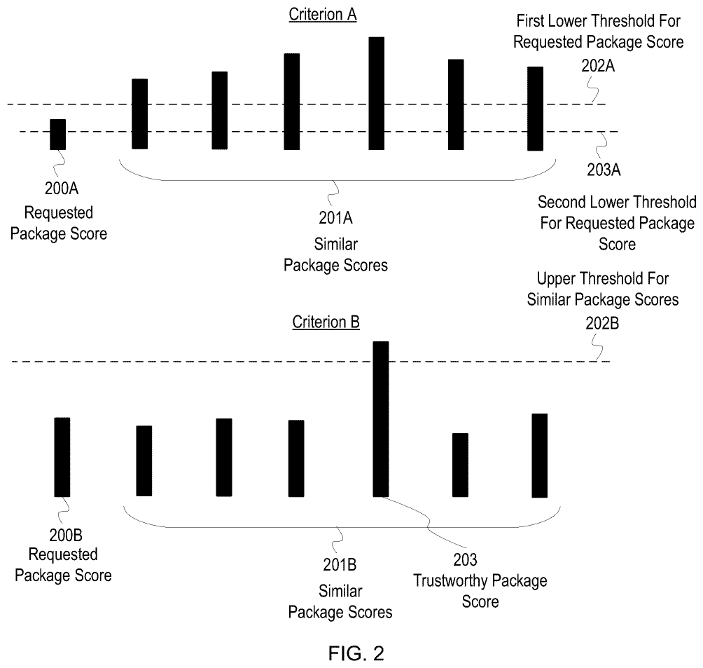

FIG. 2 is an illustrative diagram of criteria for detecting typosquatting and trustworthy packages based on trustworthiness scores of a requested package and packages with similar identifiers. For a first criterion A, a requested package score 200A is below a first lower threshold 202A for the requested package score based on similar package scores 201A (i.e., scores of packages with similar identifiers) and above a second lower threshold 203A for the requested package score. The thresholds 202A, 203A are chosen as the maximum of the similar package scores 201A minus tunable constant (fixed) score values. Criterion A is that the requested package score 200A is above the threshold 203A and below the threshold 202A and corresponds to corrective action of issuing an alert asking a user whether to proceed with the pull request. An additional criterion is that the requested package score 200A is below the threshold 203A which corresponds to corrective action of automatically terminating the pull request. For a second criterion B, a trustworthy package score 203 is above an upper threshold for similar package scores 202B determined based on similar package scores 201B and a requested package score 200B. Note that the upper threshold for similar package scores 202B is determined for the (maximal) trustworthy package score 203 as the maximum of distinct package scores in the similar package scores 201B (excluding the trustworthy package score 203) and the requested package score 200B plus a tunable constant. Because the trustworthy package score 203 is above the upper threshold for similar package scores 202B, the trustworthy package score 203 satisfies criterion B and the corresponding package is a trustworthy alternative to the package corresponding to the requested package score 200A.

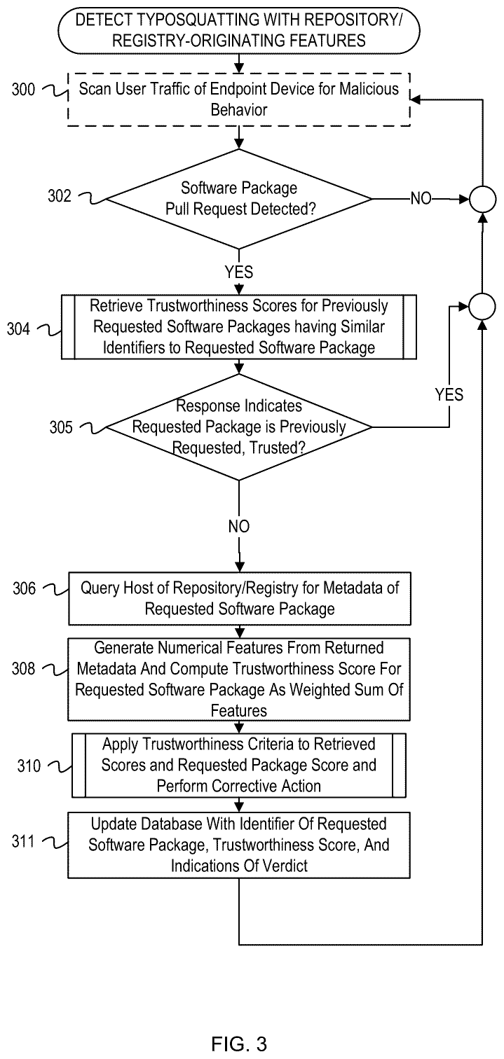

FIGS. 3-6 are flowcharts of example operations for detecting typosquatting using features generated from metadata of packages, generating trustworthiness scores from the package metadata, and applying criteria to trustworthiness scores of packages with similar identifiers. The example operations are described with reference to a typosquatting detection agent (“agent”), a host, a trustworthiness score database (“database”), and an endpoint device for consistency with the earlier figure(s) and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 3 is a flowchart of example operations for detecting typosquatting with repository/registry-originating features. At block 300, a typosquatting detection agent (“agent”) scans user traffic of an endpoint device for malicious behavior. The agent can be running inline on the endpoint device or on a firewall in the cloud monitoring Internet traffic to and from the device. The agent can log events (e.g., by logging pcap files) in the user traffic and associate events with sessions/flows as well as applications related to the sessions/flows. The agent can associate a subset of applications/destination IP addresses with potential typosquatting (e.g., applications that facilitate downloading packages from a repository or registry) and can monitor flows/sessions associated thereof for pull requests. Block 300 is depicted with dashed lines to indicate that the agent monitors user traffic independently and in parallel to the remaining operations in FIG. 3 to maintain security at the endpoint device and continues to monitor user traffic until an external force (e.g., an administrator managing security settings at the endpoint device) intervenes.

At block 302, the agent determines whether a software package pull request is detected. For an inline deployment, the agent can monitor processes by applications that are associated with typosquatting and can determine that one or more processes launched for those applications indicate a pull request. Alternatively, for both an inline and cloud deployment the agent can monitor packets in sessions/flows for applications and/or destination IP addresses associated with package repositories/registries to determine whether a pull request is indicated in logs of the packets and/or can extract application layer information to detect any pull requests. If the agent determines that a pull request is detected, flow proceeds to block 304. Otherwise, flow returns to block 300 for continued scanning of user traffic at the endpoint device.

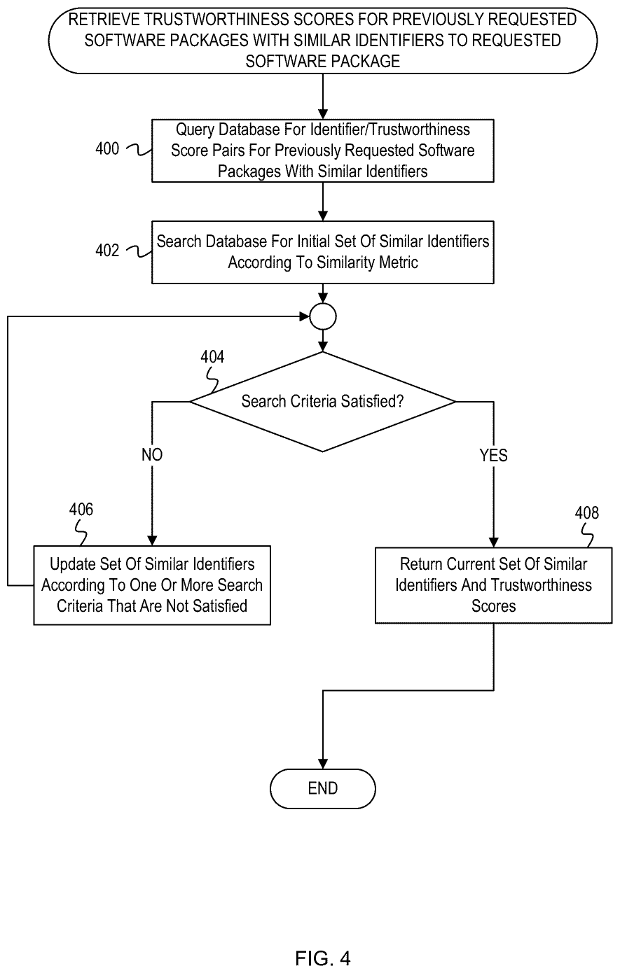

At block 304, the agent retrieves trustworthiness scores for software packages having similar identifiers to the software package indicated in the pull request from a trustworthiness score database (“database”). The operations at block 304 are depicted in greater detail in reference to FIG. 4.

At block 305, the agent determines whether the response from the database indicates that the requested package is previously requested and trusted. The agent can determine that a repository/registry associated with a previously requested package returned by the database is the same as the repository/registry corresponding to the requested package, that the previously requested package has a same identifier as the requested package, and that a trustworthiness score for the previously requested package is above a threshold score and/or that the previously requested package had a benign verdict. The agent can use further criteria in determining whether the requested package is trusted such as that the previously requested package was analyzed for typosquatting within a recent time period. If the agent determines that the requested package is previously requested and trusted, flow returns to block 302. Otherwise, flow proceeds to block 306.

At block 306, the agent queries the host of the repository/registry for metadata of the requested software package. The query indicates an identifier of the requested software package and can further include syntax that specifies desired metadata fields. In some embodiments, the query is to a URL hosted by the host that corresponds to the requested software package and in other embodiments, the query is via an API of a service run by the host that allows for pull requests and metadata queries to the repository/registry. Example metadata fields in the query to the host that indicate trustworthiness of the requested software package include a source, a number of stars, a number of tags, a number of downloads, a registration date of the publisher, a number of previous images of the publisher, an average number of image stars of the publisher, etc.

At block 308, the agent generates numerical features from metadata returned by the host and computes a trustworthiness score for the requested software package as a weighted sum of the features. The agent converts string metadata fields to numerical features and normalizes the numerical features (e.g., to lie in a same interval or to match a same distribution). The trustworthiness score is then determined as a sum of each normalized numerical feature multiplied by a respective weight. The weights are determined, for instance, by a domain-level expert based on known importance for typosquatting detection or, alternatively, using regression with numerical features of previously requested packages corresponding to known typosquatting or non-typosquatting instances. At blocks 306 and 308, the agent can additionally generate scores for one or more of the software packages having similar identifiers as these scores become deprecated by following the same method of querying respective hosts and generating numerical features/scores from the returned metadata.

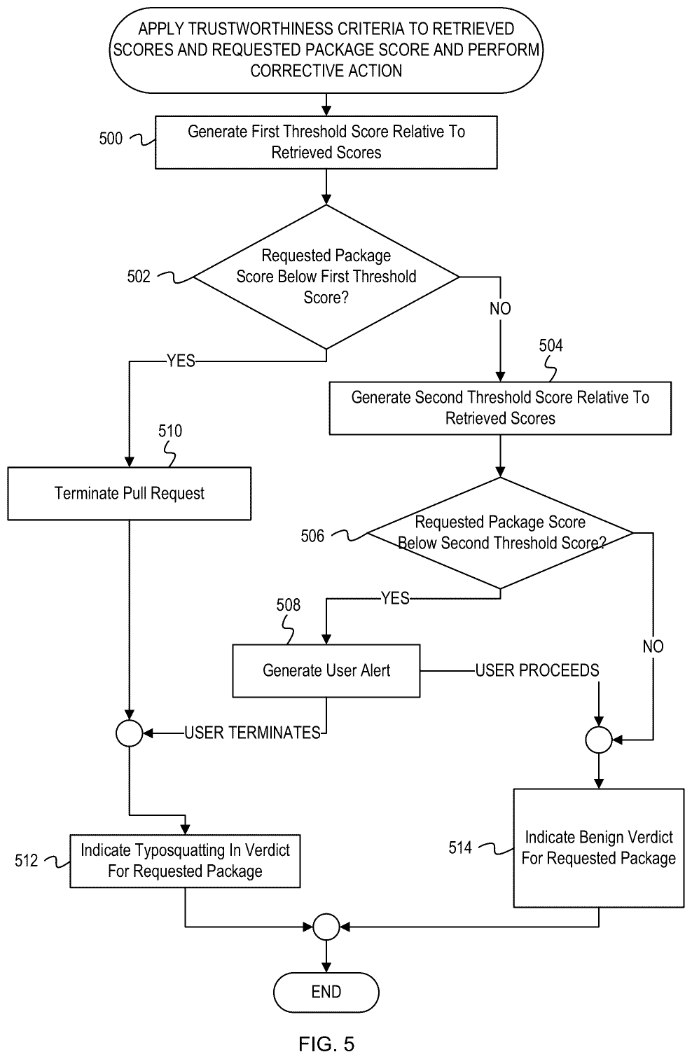

At block 310, the agent applies trustworthiness criteria to the retrieved scores and the requested package score and performs corrective action. The operations at block 310 are described in greater detail in reference to FIG. 5.

At block 311, the agent communicates the identifier of the requested software package, the trustworthiness score, and indications of the verdict to the database for updates. When the identifier is already present in the database but corresponds to a package at a separate repository to the requested software package, the database can generate an additional entry with the same identifier for the package/container and additional information to distinguish repositories. For instance, the identifiers can be concatenated with repository names. The tuple of the identifier, trustworthiness score, and verdict can be stored as a data structure that facilitates efficient retrieval. The database can further store an identifier of the repository of the requested software package and a time stamp of when the typosquatting verdict occurred in association with this tuple to inform subsequent determinations of whether requested software packages have been previously requested. Flow returns to block 300.

FIG. 4 is a flowchart of example operations for retrieving trustworthiness scores for previously requested software packages with similar identifiers to a requested software package. At block 400, a typosquatting detection agent (“agent”) queries a trustworthiness score database (“database”) for identifier/trustworthiness score pairs for previously requested software packages with similar identifiers to the requested software package. The query indicates an identifier of the requested software package. The query can further indicate a threshold similarity score for similar identifiers in the database, a maximal number of similar identifiers, and any other desired search parameters.

At block 402, the database searches for an initial set of similarity identifiers according to the similarity metric. For instance, the database can comprise a BK-tree data structure that facilitates efficient lookup for similar strings according to Levenshtein or other similarity distance. A simpler implementation is to compute a Levenshtein distance between the identifier of the requested software package and all of the identifiers stored in the database, sort the identifiers in the database by Levenshtein distance, and take the n-closest identifiers or identifiers within a threshold Levenshtein distance. Note that this approach can be applied for any similarity metric between identifiers. Embodiments can supplement a distance-based similarity with heuristics-based rules. For instance, searching for an identifier with or without a “s” as a similar identifier.

At block 404, the database determines whether search criteria are satisfied. The search criteria can be specified by the query from the agent to the database or can be hard coded rules. For instance, the search criteria can be that the number of identifiers is below an upper threshold number of identifiers, that each identifier is below a threshold similarity metric value, etc. In some embodiments where a threshold similarity metric value can lead to zero packages with identifiers sufficiently close, the search criteria can be that the number of identifiers is above a lower threshold number of identifiers. If the search criteria are satisfied, flow proceeds to block 408. Otherwise, flow proceeds to block 406.

At block 406, the database updates the set of similar identifiers according to one or more search criteria that are not satisfied. For instance, the database can cutoff the number of identifiers to the n-closest identifiers according to a similarity metric where n is an upper threshold number of acceptable identifiers. The database can remove identifiers above a threshold similarity metric distance d from the identifier of the requested software package. If the number of similar identifiers is below a lower threshold number of similarity metric values, the database can increase the threshold similarity metric distance d to allow for additional similar identifiers. Flow returns to block 404.

At block 408, the database returns the current set of similar identifiers to the identifier of the requested software package and their corresponding trustworthiness scores. The database can further return similarity metric values from each of the similar identifiers to the identifier of the requested software package. The database can retrieve the trustworthiness scores as it generates similarity metric values according to the aforementioned operations or it can retrieve the trustworthiness scores once the final (current) set of similar identifiers is determined. The trustworthiness scores can be associated with identifiers as a hash data structure in the database for efficient retrieval. In embodiments where one of the similar identifiers is identical to the identifier of the requested software package, the database can retrieve and return additional data such as a repository where the previously requested package was pulled from and when the previously requested request was evaluated for typosquatting.

FIG. 5 is a flowchart of example operations for applying trustworthiness criteria to retrieved scores and a requested package score to generate a verdict for a software package request. The verdict indicates whether typosquatting occurs and, if no typosquatting occurs, indicates that the software package request is benign. Nonetheless, the software package request can be vulnerable to disparate attack vectors and additional monitoring/analysis may still be required as the software package is downloaded and installed/executed at an endpoint device subsequent to a benign verdict.

At block 500, a typosquatting detection agent (“agent”) generates a first threshold score relative to the retrieved scores. The first threshold score can be chosen as any threshold less than the retrieved scores to determine whether the requested package score is significantly below the scores for packages with similar identifiers. For instance, denoting the retrieved scores as {sᵢ}ᵢ₌₁ⁿ and

$${s}_{j} = {max}_{i} ( {s}_{i} ) ,$$

then the first threshold score can be sⱼ−τ₁ for some tunable parameter τ₁, i.e., the maximum of the scores minus the tunable parameter.

At block 502, the agent determines whether the requested package score is below the first threshold score. Denoting the requested package score s, then the agent determines whether s<sⱼ−τ₁. If the agent determines the requested package score is below the first threshold score, flow skips to block 510. Otherwise, flow proceeds to block 504.

At block 504, the agent generates a second threshold score relative to the retrieved scores and the requested package score. For instance, using the above notation the second threshold score can be sⱼ−τ₂, i.e., the maximal of the retrieved scores minus a tunable parameter τ₂<τ₁. The parameters τ₂ and τ₁ can be tuned according to scores of previous typosquatting pull requests or according to statistics of any of the package scores.

At block 506, the agent determines whether the requested package score is below the second threshold score. Using the above notation, the agent determines whether s<sⱼ−τ₂. If the agent determines that the requested package score is below the second threshold score, flow proceeds to block 508. Otherwise, flow proceeds to block 514.

At block 508, the agent generates a user alert for the requested package. The user alert indicates an identifier of the requested package and a prompt asking the user whether to proceed with the pull request at an endpoint device. Additionally, the user alert can indicate additional metadata associated with the package such as an associated repository, a trustworthiness score, etc. If the user decides to proceed with the pull request, flow proceeds to block 514. Otherwise, flow proceeds to block 512.

At block 510, the agent terminates the pull request. The agent terminates or sends instructions to terminate any sessions, flows, or processes associated with downloading, installing, and/or executing content from typosquatting. The agent can further instruct an endpoint device that communicated the pull request to delete local data downloaded from the pull request and can alert a user of the endpoint device that the pull request was terminated due to typosquatting. Flow proceeds to block 512.

At block 512, the agent indicates typosquatting in a verdict for the requested package. The agent can further indicate a confidence of the typosquatting verdict. The confidence can be determined according to the difference sⱼ−s, i.e., how much smaller the trustworthiness score is for the requested package is than the maximal trustworthiness score for packages with similar identifiers. The verdict can further associate a trustworthy package as the package having a similar identifier with a maximal trustworthiness score among the retrieved scores that is sufficiently larger than all of the distinct retrieved scores and the requested package score.

At block 514, the agent indicates a benign verdict for the requested package. Subsequently, the agent allows flows/sessions associated with the requested package and processes associated with downloading/installing/executing the requested package at an endpoint device. The agent continues to monitor user traffic/processes on the endpoint device related to the package for malicious behavior.

In the above operations for FIG. 5, the score of the requested package is compared to a maximal score of packages with similar identifiers. Depending on algorithmic implementation, the score of the requested package can instead be pairwise compared to scores of each of the packages with similar identifiers. This avoids the need to determine the maximal score of packages with similar identifiers while incurring the cost of performing pairwise score comparisons.

### VARIATIONS

The above disclosure is described with reference to software packages. Any instance of the term “software package” or “package” can be replaced with a “container” or “container image” while equivalently maintaining the recited operations, methods, components, techniques, etc. with appropriate modifications such as adapting to APIs of container repository services versus software package services, appropriately interfacing with hosts of such services, terminating flows/sessions/processes as determined by the manner with which endpoint devices download/acquire software packages versus container images when typosquatting is detecting, etc.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 500/502 and 504/506 can be performed in parallel or concurrently. The operations at blocks 304 and 306 can occur in any order. FIG. 5 is depicted as applying two criteria to trustworthiness scores for typosquatting detection, wherein typosquatting corresponds to failing either criteria, whereas in other embodiments, more or less criteria can be applied, a typosquatting verdict may only apply when multiple criteria are satisfied, etc. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

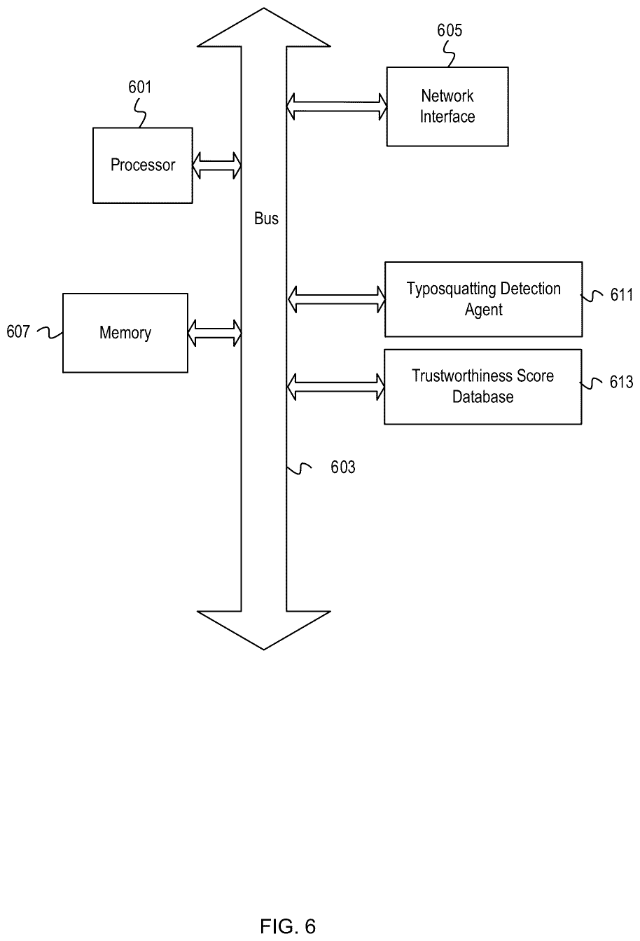

FIG. 6 depicts an example computer system with a typosquatting detection agent and a trustworthiness score database. The computer system includes a processor 601 (possibly including multiple processors, multiple cores, multiple nodes, and/or implementing multi-threading, etc.). The computer system includes memory 607. The memory 607 may be system memory or any one or more of the above already described possible realizations of machine-readable media. The computer system also includes a bus 603 and a network interface 605. The system also includes a typosquatting detection agent (“agent”) 611 and a trustworthiness score database (“database”) 613. The agent 611 detects a pull request for a package or container from user traffic at an endpoint device and queries the database 613 for trustworthiness scores of similarly identified packages or containers and queries a host of a repository of the package or container for metadata thereof. The database 613 returns trustworthiness score/identifier pairs for packages or containers with similar identifiers. The agent 611 determines a trustworthiness score for the requested package or container based on the returned metadata, applies criteria to this score and the returned scores to identify typosquatting, and performs corrective action for the endpoint device based on identified typosquatting. Any one of the previously described functionalities may be partially (or entirely) implemented in hardware and/or on the processor 601. For example, the functionality may be implemented with an application specific integrated circuit, in logic implemented in the processor 601, in a co-processor on a peripheral device or card, etc. Further, realizations may include fewer or additional components not illustrated in FIG. 6 (e.g., video cards, audio cards, additional network interfaces, peripheral devices, etc.). The processor 601 and the network interface 605 are coupled to the bus 603. Although illustrated as being coupled to the bus 603, the memory 607 may be coupled to the processor 601.

1. A method comprising:
determining trustworthiness of at least one of a software package and a container in response to detection of a request to retrieve the at least one of software package and container, wherein determining trustworthiness comprises,
determining a first score for a first identifier of the at least one of software package and container, wherein the first score indicates trustworthiness of the at least one of software package and container;
retrieving a plurality of identifiers for at least one of software packages and containers satisfying a similarity criterion with the first identifier, wherein each of the plurality of identifiers has one of a plurality of scores indicating trustworthiness of a corresponding software package or container;
determining whether the first score is below a first threshold score, wherein the first threshold score is relative to the plurality of scores; and
based a determination that the first score is below the first threshold score, indicating the software package as package typosquatting; and
rejecting the request based on the determination of trustworthiness of the at least one of software package and container.

2. The method of claim 1, wherein the first threshold score comprises a difference between a maximum of the plurality of scores and a fixed score value.

3. The method of claim 1, further comprising,
based on a determination that the first score is above the first threshold score, determining whether the first score is below a second threshold score, wherein the second threshold score is relative to the plurality of scores and greater than the first threshold score; and
based on a determination that the first score is below the second threshold score, generate an alert for the request that indicates potential typosquatting.

4. The method of claim 3, further comprising, based on a determination that the first score is above the second threshold score, indicating the at least one of software package and container as benign.

5. The method of claim 3, further comprising, based on a user indication to proceed with the request in response to the alert, indicating the at least one of software package and container as benign.

6. The method of claim 1, wherein the first identifier is indicated in a request to one or more repositories for the at least one of software package and container.

7. The method of claim 1, wherein the similarity criterion comprises a determination that a similarity metric value between a second identifier and the first identifier is below a threshold similarity metric value.

8. The method of claim 7, wherein the similarity metric value comprises a Levenshtein distance between the first identifier and the second identifier.

9. The method of claim 1, wherein the first score comprises a weighted sum of at least two of number of downloads, a source feature, a number of stars, a number of tags, and one or more publisher features for the at least one of software package and container.

10. A non-transitory, machine-readable medium having program code stored thereon, the program code comprising instructions to:
detect a request to one or more repositories indicating a first identifier for at least one of a software package and a container stored at the one or more repositories;
determine a first score indicating trustworthiness of the at least one of software package and container indicated by the first identifier based, at least in part, on metadata associated with the at least one of software package and container;
retrieve a plurality of identifiers for at least one of software packages and containers satisfying a similarity criterion with the first identifier, wherein each of the plurality of identifiers has one of a plurality of scores indicating trustworthiness of a corresponding software package or container;
determine whether the plurality of scores and the first score satisfy one or more criteria for trustworthiness of the at least one of software package and container indicated by the first identifier; and
based on a determination that the plurality of scores and the first score fail at least one of the one or more criteria, perform corrective action on the request to the one or more repositories.

11. The machine-readable media of claim 10, wherein the one or more criteria for trustworthiness of the at least one of software package and container indicated by the identifier comprise a determination of whether the first score is above a first threshold score, wherein the first threshold score is based, at least in part, on the plurality of scores.

12. The machine-readable media of claim 10, wherein the similarity criterion comprises a determination that a similarity metric value between a second identifier and the first identifier is below a threshold similarity metric value.

13. The machine-readable media of claim 10, wherein the program code further comprises instructions to, based on a determination that the plurality of scores and the first score satisfy the one or more criteria, indicate the at least one of software package and container as benign.

14. The machine-readable media of claim 10, wherein the first score comprises a weighted sum of at least two of a number of downloads, a source feature, a number of stars, a number of tags, and one or more publisher features indicated in the metadata of the at least one of software package and container.

15. An apparatus comprising:
a processor; and
a machine-readable medium having instructions stored thereon that are executable by the processor to cause the apparatus to,
detect a request to one or more repositories indicating a first identifier for at least one of a software package and a container stored at the one or more repositories;
query one or more hosts of the one or more repositories for metadata associated with the at least one of software package and container indicated by the first identifier;
determine a first score indicating trustworthiness of the at least one of software package and container indicated by the first identifier based, at least in part, on the metadata returned by the one or more hosts;
retrieve a plurality of identifiers for at least one of software packages and containers satisfying a similarity criterion with the first identifier, wherein each of the plurality of identifiers has one of a plurality of scores indicating trustworthiness of a corresponding software package or container;
determine whether the plurality of scores and the first score satisfy one or more criteria for trustworthiness of the at least one of software package and container indicated by the first identifier; and
based on a determination that the plurality of scores and the first score fail the one or more criteria, terminate the request to the one or more repositories.

16. The apparatus of claim 15, wherein the one or more criteria for trustworthiness of the at least one of software package and container indicated by the first identifier comprise a determination of whether the first score is above a first threshold score, wherein the first threshold score is based, at least in part, on the plurality of scores.

17. The apparatus of claim 15, wherein the at least one of software package and container comprises a container image.

18. The apparatus of claim 15, wherein the machine-readable medium further has stored thereon instructions executable by the processor to cause the apparatus to store the first identifier in association with the first score for detection of potentially malicious requests to the one or more repositories.

19. The apparatus of claim 15, wherein the first score comprises a weighted sum of at least two of number of downloads, a source feature, a number of stars, a number of tags, and one or more publisher features indicated in the metadata of the at least one of software package and container.

20. The apparatus of claim 15, wherein the instructions to terminate the request to the one or more repositories comprise instructions executable by the processor to cause the apparatus to terminate one or more connections between the one or more hosts and an endpoint device that made the request.
